(19) United States
(12) Patent Application Publication
(10) Pub. No.: US 2018/0051409 A1
(43) Pub. Date: Feb. 22, 2018

(54) FAN ASSEMBLY FOR A DRYER APPLIANCE

(71) Applicant: Haier US Appliance Solutions, Inc., Wilmington, DE (US)

(72) Inventors: Zhiquan Yu, Mason, OH (US); James Pollett, Louisville, KY (US)

(21) Appl. No.: 15/239,903

(22) Filed: Aug. 18, 2016

(51) Int. Cl. D06F 58/20; D06F 58/02; F04D 17/16; F04D 29/28; F04D 29/44; F04D 29/30; F04D 29/42

(52) U.S. Cl. CPC D06F 58/20; D06F 58/02; F04D 17/16; F05B 2250/712; F04D 29/444; F04D 29/30; F04D 29/4226; F04D 29/281

(57) ABSTRACT

A fan assembly for a dryer appliance is provided. The fan assembly includes an inlet duct that fluidly couples a chamber of the dryer appliance to a fan inlet. The inlet duct includes one or more guide vanes that are configured to direct the air in a manner that improves the pressure rise across the fan, thereby improving appliance performance. For example, the guide vanes may be positioned and oriented to generate a negative pre-swirl of the flow of air, such that the flow of air enters the fan inlet rotating in a direction opposite the direction of rotation of an impeller. Additionally, or alternatively, one or more guide vanes may be positioned and oriented to generate a laminar flow of otherwise turbulent air from the chamber of the dryer appliance.

### FIELD OF THE INVENTION

The present subject matter relates generally to fan assemblies for appliances, such as dryer appliances.

### BACKGROUND OF THE INVENTION

Dryer appliances generally include a cabinet with a drum rotatably mounted therein. A motor can selectively rotate the drum during operation of the dryer appliance, e.g., to tumble articles located within a chamber defined by the drum. Dryer appliances also generally include a heater assembly that passes heated air through the chamber of the drum in order to dry moisture laden articles disposed within the chamber.

To circulate heated air, certain dryer appliances include a fan assembly positioned within a housing. During operation of the dryer appliance, an impeller of the fan assembly urges a flow of heated air into the chamber of the drum. Such heated air absorbs moisture from articles disposed within the chamber. The impeller also urges moisture laden air out of the chamber through a vent. The vent can be connected to household ductwork that directs the moisture laden air outdoors.

Performance of a dryer appliance can be affected by the flow of heated air. For example, dryer appliance performance can be improved by generating a large volume of heated air. Conversely, dryer appliance performance can be negatively affected if the heating assembly generates a low volume of heated air.

To improve dryer performance, a size of the impeller can be increased. However, space with a dryer appliance is generally limited or constrained. Thus, increasing a size of the impeller can be difficult. To improve dryer performance, certain dryer appliances include a second motor configured to rotate the impeller. However, motors can be expensive, and adding the second motor to the dryer appliance can increase the cost of the dryer appliance.

Accordingly, a dryer appliance with features for improving air flow through the dryer appliance would be useful. In particular, a dryer appliance with features for improving air flow through the dryer appliance without requiring a relatively large impeller or adding a second motor to the dryer appliance would be useful.

### BRIEF DESCRIPTION OF THE INVENTION

The present subject matter provides a fan assembly for a dryer appliance. The fan assembly includes an inlet duct that fluidly couples a chamber of the dryer appliance to a fan inlet. The inlet duct includes one or more guide vanes that are configured to direct the air in a manner that improves the pressure rise across the fan, thereby improving appliance performance. For example, the guide vanes may be positioned and oriented to generate a negative pre-swirl of the flow of air, such that the flow of air enters the fan inlet rotating in a direction opposite the direction of rotation of an impeller. Additionally, or alternatively, one or more guide vanes may be positioned and oriented to generate a laminar flow of otherwise turbulent air from the chamber of the dryer appliance. Additional aspects and advantages of the invention will be set forth in part in the following description, or may be apparent from the description, or may be learned through practice of the invention.

In a first exemplary embodiment, a dryer appliance is provided. The dryer appliance defines a vertical direction. The dryer appliance includes a cabinet defining a vent; a drum rotatably mounted within the cabinet, the drum defining a chamber for receipt of articles for drying; a motor; and a fan assembly defining an axial direction, a radial direction, and a circumferential direction. The fan assembly includes an impeller, the impeller being in mechanical communication with the motor and rotatable about the axial direction to urge a flow of air from the chamber of the drum to the vent of the cabinet. An inlet duct extends between and fluidly couples the chamber and a fan inlet. A guide vane is positioned within the inlet duct and oriented for directing the flow of air within the inlet duct, the guide vane defining an upstream end proximate the chamber and a downstream end proximate the fan inlet, the downstream end of the guide vane defining a tangent line. An exhaust duct extends between and fluidly couples a fan outlet and the vent of the cabinet.

In a second exemplary embodiment, a fan assembly for urging a flow of air from a chamber of a dryer appliance is provided. The dryer appliance defines a vertical direction, a lateral direction, and a transverse direction. The fan assembly includes an impeller being rotatable about an axis of rotation in a direction of rotation, the axis of rotation being substantially parallel to the transverse direction. An inlet duct extends between and fluidly couples the chamber and a fan inlet, the inlet duct being defined by a first side wall and a second side wall separated along the transverse direction and a top wall and a bottom wall separated along the vertical direction. A guide vane extends between the first side wall and the second side wall of the inlet duct, the guide vane defining an upstream end proximate the chamber and a downstream end proximate the fan inlet, the downstream end of the guide vane defining a tangent line that substantially aligns with a primary direction of the flow of air.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a dryer appliance according to an exemplary embodiment of the present subject matter.

FIG. 2 provides a perspective view of the exemplary dryer appliance of FIG. 1 with a portion of a cabinet of the exemplary dryer appliance removed to reveal certain internal components of the exemplary dryer appliance.

FIG. 3 provides a perspective view of a fan assembly according to an exemplary embodiment of the present subject matter.

FIG. 4 provides a front view of an impeller and an exhaust duct of the exemplary fan assembly of FIG. 3.

FIG. 5 provides a front cross sectional view of an inlet duct and a guide vane of the exemplary fan assembly of FIG. 3.

FIG. 6 provides a plot illustrating the pressure rise generated by the exemplary fan assembly of FIG. 3 with and without the exemplary guide vane of FIG. 5.

FIG. 7 provides a front cross sectional view of the inlet duct and a plurality of guide vanes according to an alternative exemplary embodiment of the present subject matter.

FIG. 8 provides a plot illustrating the pressure rise generated by the exemplary fan assembly of FIG. 3 with and without the plurality of guide vanes of FIG. 7.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to fabrics, textiles, garments (or clothing), and linens. Furthermore, the term “load” or “laundry load” refers to the combination of articles that may be washed together in a washing machine or dried together in a laundry dryer (i.e., a clothes dryer) and may include a mixture of different or similar articles of different or similar types and kinds of fabrics, textiles, garments and linens within a particular laundering process.

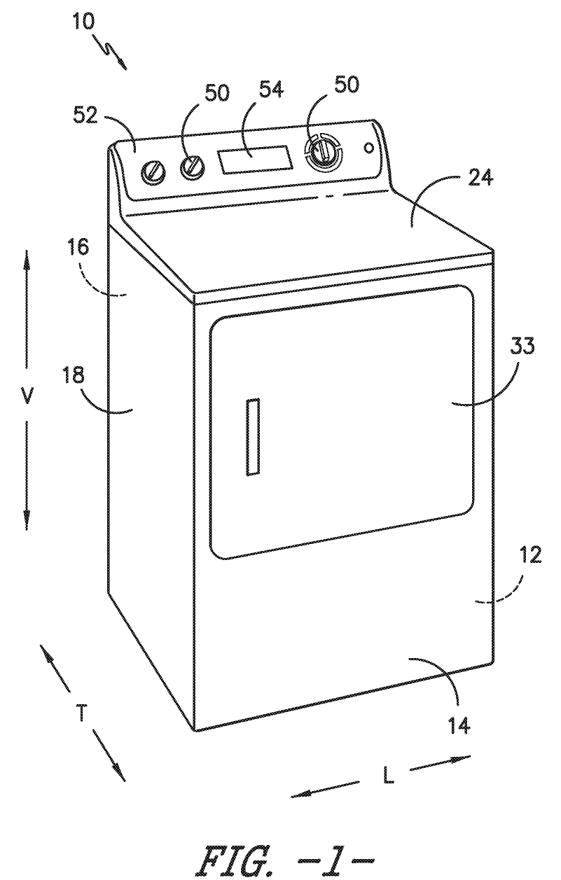

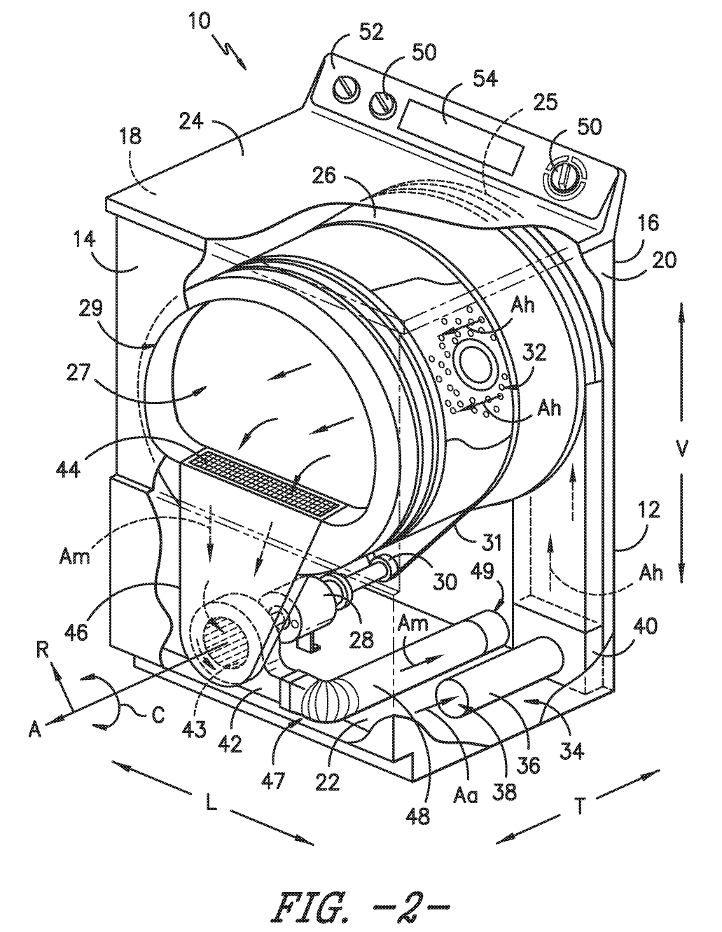

FIGS. 1 and 2 illustrate a dryer appliance 10 according to an exemplary embodiment of the present subject matter. While described in the context of a specific embodiment of dryer appliance 10, using the teachings disclosed herein it will be understood that dryer appliance 10 is provided by way of example only. Other dryer appliances having different appearances and different features may also be utilized with the present subject matter as well. For example, dryer appliance 10 illustrated in FIGS. 1 and 2 is a gas dryer appliance with a combustion chamber 36. In alternative exemplary embodiments, dryer appliance 10 may be an electric dryer appliance with electric heating elements replacing combustion chamber 36.

Dryer appliance 10 generally defines a vertical direction V, a lateral direction L, and a transverse direction T, which are mutually perpendicular with one another, such that an orthogonal coordinate system is generally defined. Dryer appliance 10 includes a cabinet 12 having a front panel 14 and a rear panel 16 spaced apart from each other along the transverse direction T. In addition, cabinet 12 includes a pair of side panels 18 and 20 spaced apart from each other by front and rear panels 14 and 16 along the lateral direction L. A bottom panel 22 and a top cover 24 are also spaced apart along the vertical direction V. Within cabinet 12 is a drum or container 26 mounted for rotation about an axis that is substantially parallel with the transverse direction T. Drum 26 is generally cylindrical and defines a chamber 27 for receipt of damp articles.

Drum 26 also defines an opening 29 for permitting access to the chamber 27 of drum 26. Opening 29 of drum 26, e.g., permits loading and unloading of clothing articles and other fabrics from chamber 27 of drum 26. A door 33 is rotatably mounted at opening 29 and selectively hinders access to chamber 27 of drum 26 through opening 29.

Drum 26 includes a rear wall 25 rotatably supported within cabinet 12 by a suitable fixed bearing. Rear wall 25 can be fixed or can be rotatable. A motor 28 rotates the drum 26 about the transverse direction T through a pulley 30 and a belt 31. Motor 28 is also in mechanical communication with a fan or air handler 42 such that motor 28 rotates an impeller 43, e.g., a centrifugal impeller, of air handler 42. Air handler 42 is configured for drawing air through chamber 27 of drum 26, e.g., in order to dry articles located therein as discussed in greater detail below. In alternative exemplary embodiments, dryer appliance 10 may include an additional motor (not shown) for rotating impeller 43 of air handler 42 independently of drum 26.

Drum 26 is configured to receive heated air that has been heated by a heater assembly 34, e.g., in order to dry damp articles disposed within chamber 27 of drum 26. Heater assembly 34 includes a combustion chamber 36. As discussed above, during operation of dryer appliance 10, motor 28 rotates drum 26 and impeller 43 of air handler 42 such that air handler 42 draws air through chamber 27 of drum 26 when motor 28 rotates impeller 43. In particular, ambient air, shown with arrow Aₐ, enters combustion chamber 36 via an inlet 38 due to air handler 42 urging such ambient air Aₐ into inlet 38. Such ambient air Aₐ is heated within combustion chamber 36 and exits combustion chamber 36 as heated air, shown with arrow Aₕ. Air handler 42 draws such heated air Aₕ through a back duct 40 to drum 26. The heated air Aₕ enters drum 26 through a plurality of holes 32 defined in rear wall 25 of drum 26.

Within chamber 27, the heated air Aₕ can accumulate moisture, e.g., from damp articles disposed within chamber 27. In turn, air handler 42 draws moisture laden air, shown as arrow Aₘ, through a screen filter 44 which traps lint particles. Such moisture laden air Aₘ then enters a front duct 46 and is passed through air handler 42 to an exhaust duct 48. From exhaust duct 48, such moisture laden air Aₘ passes out of clothes dryer 10 through a vent 49 defined by cabinet 12.

Front duct 46 and exhaust duct 48 form a conduit 47 that extends between and connects chamber 27 of drum 26 and vent 49. Conduit 47 places chamber 27 of drum 26 and vent 49 in fluid communication in order to permit moisture laden air Aₘ to exit dryer appliance 10. Air handler 42 is in fluid communication with conduit 47, and impeller 43 of air handler 42 is positioned within conduit 47.

A cycle selector knob 50 is mounted on a cabinet backsplash 52 and is in communication with a controller 54. Signals generated in controller 54 operate motor 28 and heater assembly 34 in response to a position of selector knob 50. Alternatively, a touch screen type interface may be provided. As used herein, “processing device” or “controller” may refer to one or more microprocessors or semiconductor devices and is not restricted necessarily to a single element. The processing device can be programmed to operate dryer appliance 10. The processing device may include, or be associated with, one or memory elements such as e.g., electrically erasable, programmable read only memory (EEPROM).

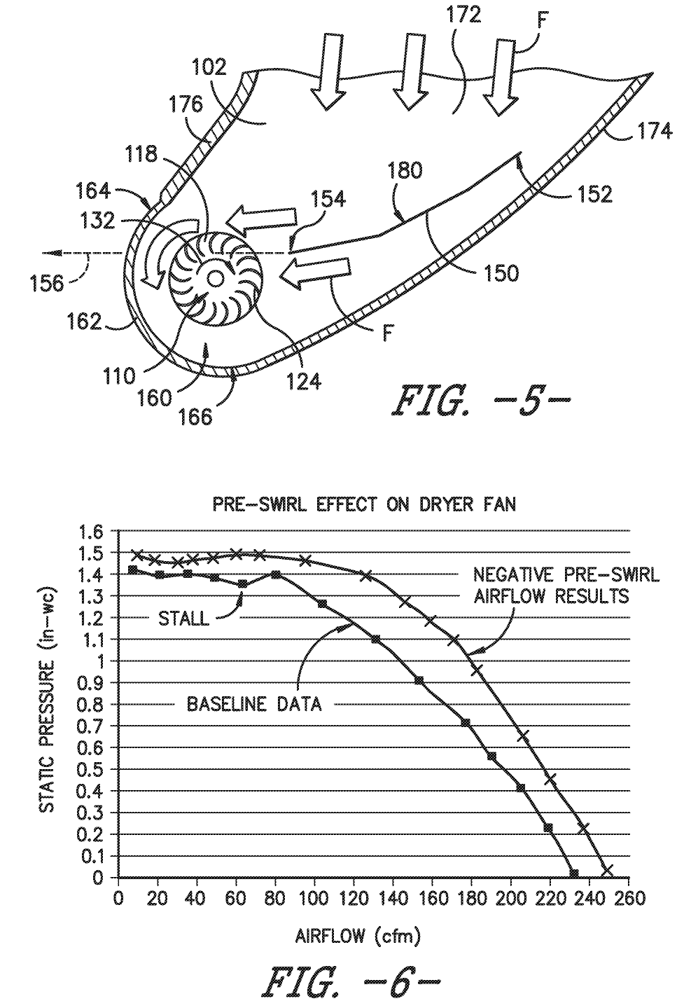

FIG. 3 provides a perspective view of a fan assembly 100 according to an exemplary embodiment of the present subject matter. Fan assembly 100 may be used in any suitable dryer appliance. For example, fan assembly 100 may be used in dryer appliance 10, e.g., as air handler 42 (FIG. 2). Thus, fan assembly 100 may be positioned within cabinet 12, e.g., at front duct 46, such that fan assembly 100 draws in and receives moisture laden air Aₘ from chamber 27 of drum 26. As discussed in greater detail below, fan assembly 100 includes features for increasing a pressure rise and flow rate of a flow of air F (FIG. 5) passing through fan assembly 100. Performance of dryer appliance 10 may be improved by increasing the pressure rise and flow rate of the flow of air F through fan assembly 100, as will be understood by those skilled in the art.

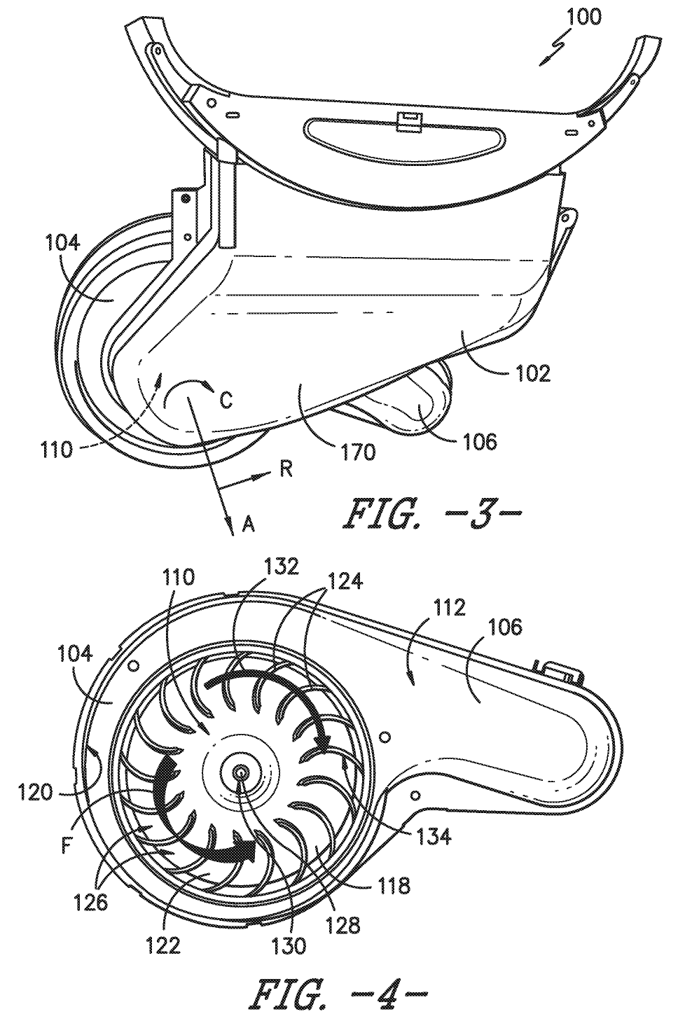

Referring now generally to FIGS. 3 and 4, fan assembly 100 includes an inlet duct 102, a fan housing 104, and an exhaust duct 106. Fan housing 104 may define a fan inlet 110 and a fan outlet 112, and may generally couple inlet duct 102 and exhaust duct 106, e.g., to form a single conduit such as conduit 47 (FIG. 2). More specifically, inlet duct 102 extends between and fluidly couples chamber 27 and fan inlet 110, and exhaust duct 106 extends between and fluidly couples fan outlet 112 and vent 49 of cabinet 12. In this manner, fan assembly 100 provides a continuous flow path for directing the flow of air F, e.g., including moisture laden air Aₘ, from chamber 27 and out of vent 49.

As shown in FIG. 3, according to the exemplary embodiment, fan assembly 100 generally defines an axial direction A, e.g., that is substantially parallel to the transverse direction T of dryer appliance 10. Fan assembly further defines a radial direction R that extends perpendicular to the axial direction A and a circumferential direction C that extends around the axial direction A in a plane defined by the radial direction R. Fan assembly 100 may further include an impeller 118 that is rotatably mounted within fan housing 104 and has an axis of rotation extending substantially parallel to the axial direction A. As used herein, when used to specify a directional orientation, “substantially” is intended to refer to within ten degrees of the stated direction.

As illustrated, fan housing 104 defines a volute 120 of fan housing 104 that is sized and configured for receiving impeller 118. Impeller 118 includes a base plate 122 and a plurality of blades 124 extending therefrom. More specifically, the plurality of blades 124 extend from base plate 122 toward the fan inlet 110 substantially along the axial direction A. Base plate 122 and blades 124 thereby define a plurality of passages 126 for directing the flow of air F during rotation of impeller 118 about the axial direction A. Blades 124 are spaced apart from each other, e.g., along the circumferential direction C. In particular, blades 124 may be spaced apart from each other such that blades 124 are uniformly dispersed or distributed along the circumferential direction C. Blades 124 may be any size, shape, and orientation suitable for drawing the flow of air F in through fan inlet 110 during rotation of impeller 118 about the axial direction A. For example, as illustrated, each of the plurality of blades 124 define a concave surface 134 oriented toward a direction of rotation (indicated by arrow 132 in FIG. 4) of the impeller 118.

Impeller 118 may be placed in mechanical communication with a motor, such as motor 28, that selectively rotates impeller 118 about an axial direction A within fan housing 104. For example, according to the illustrated embodiment, base plate 122 has a substantially circular shape, e.g., in a plane that is perpendicular to the axial direction A, such that base plate 122 is substantially disk-shaped. Base plate 122 includes a mounting feature 128 for mounting base plate 122 to a motor, such as motor 28. Mounting feature 128 is positioned at a center 130 of base plate 122 and can be any suitable mechanism for mounting impeller 118 to motor 28. For example, mounting feature 128 may include threads for securing impeller 118 to motor 28. In this manner, impeller 118 is rotated about axis of rotation in the direction of rotation 132. In this manner, impeller 118 may draw the flow of air F into impeller 118 along the axial direction A.

During operation of fan assembly 100, impeller 118 may rotate about the axial direction A within volute 120 of fan housing 104 such that impeller 118 draws the flow of air F into fan housing 104 via fan inlet 110. In addition, impeller 118 may urge the flow of air F through fan housing 104 to fan outlet 112 and exhaust duct 106 during operation of fan assembly 100. More specifically, the flow of air F may flow into fan housing 104 flowing along a direction that is substantially parallel to the axial direction A. Within volute 120, the flow of air F may be urged outward along the radial direction R, along directions that are perpendicular to the axial direction A.

Inlet duct 102, fan housing 104, and exhaust duct 106 may be constructed of or with any suitable material. For example, these components may be constructed of or with a single continuous or integral piece of plastic. Alternatively, inlet duct 102, fan housing 104, and exhaust duct 106 may be separate parts that are mechanically joined, e.g., by using mechanical fasteners or by welding. According to alternative exemplary embodiments, these components may also be constructed of a metal, such as steel.

Referring now generally to FIGS. 3 through 8, fan assembly 100 may include features for increasing the pressure rise and flow rate across fan assembly 100. In addition, or alternatively, fan assembly 100 may include features for reducing the likelihood of a stall condition or improving flow stability of fan assembly 100. As used herein, “stall” is intended to refer to a dip on the fan curve that corresponds to instability in operation due to separation of airflow along the blades of a fan. These features will be described in detail below.

As illustrated in FIG. 5, fan assembly 100 includes a guide vane 150 positioned within inlet duct 102 and oriented for directing the flow of air F within inlet duct 102. Guide vane 150 defines an upstream end 152 proximate chamber 27 and a downstream end 154 proximate fan inlet 110. The terms “upstream” and “downstream” refer to the relative direction with respect to fluid flow in a fluid pathway. For example, “upstream” refers to the direction from which the flow of air F flows, and “downstream” refers to the direction to which the flow of air F flows.

As illustrated in FIG. 5, downstream end 154 of guide vane 150 defines a tangent line 156. Notably, because guide vane 150 directs the flow of air F, tangent line 156 substantially corresponds to the primary direction of the flow of air F off guide vane 150. In order to capture the flow of air F and direct it toward fan inlet 110, inlet duct 102 defines an inlet chamber 160. Inlet chamber 160 is generally bounded by a curved end wall 162 that is configured to capture the flow of air F. More specifically, the curved end wall 162 may include a top portion 164 that is disposed above a bottom portion 166 along the vertical direction V. Inlet chamber 160 is adjacent fan inlet 110 along the axial direction A and corresponds substantially in shape with impeller 118. According to the illustrated embodiment, guide vane 150 is positioned entirely within inlet duct 102 outside of inlet chamber 160. In this manner, guide vane 150 redirects the flow of air F into inlet chamber 160 along a specific trajectory as described below. However, according to alternative embodiments, guide vane 150 may extend into inlet chamber 160.

According to an exemplary embodiment, guide vane 150 is positioned and oriented for directing the flow of air F onto or towards top portion 164 of curved end wall 162. In this manner, as shown in FIG. 5, the flow of air F swirls within inlet chamber 160 in a direction opposite a direction of rotation 132 of impeller 118. According to an exemplary embodiment, guide vane 150 may be positioned such that tangent line 156 intersects at least one of the plurality of blades 124 substantially perpendicular to concave surface 134, e.g., when viewed in a plane that is perpendicular to the axial direction A. More specifically, the flow of air F may flow into inlet chamber 160 such that its trajectory would perpendicularly strike concave surface 134 if traveling along the same plane along the axial direction A. According to another embodiment, tangent line 156 may generally intersect impeller 118 proximate top portion 164 of curved end wall 162.

According to various embodiments of the present subject matter, guide vane 150 may be any suitable size and shape. In addition, one or multiple guide vanes may be positioned and oriented in any suitable manner to achieve the results described. For example, guide vane 150 may define a length along the lateral direction L that is approximately the same as the diameter of impeller 118. Alternatively, the length of guide vane 150 along the lateral direction L may be shorter or longer than the diameter of impeller 118. For example, according to the illustrated embodiment, the length of guide vane 150 along the lateral direction L is approximately two times the diameter of impeller 118.

Guide vane 150 may extend across a depth of inlet duct 110. More specifically, inlet duct 110 may include a first side wall 170 (FIG. 3) and a second side wall 172 (FIG. 5) separated along the axial direction A. In addition, inlet duct 110 may include a bottom wall 174 and a top wall 176 separated along the vertical direction V. The depth of inlet duct 110 may be defined along the axial direction A between first side wall 170 and second side wall 172. Guide vane 150 may generally define a concave surface 180 that is oriented substantially in the vertical direction V (e.g., and/or faces screen filter 44 or chamber 27) such that it captures a large portion of the flow of air F that is flowing through inlet duct 102. According to the illustrated embodiment, bottom wall 174 is curved and is designed to redirect the flow of air F, which enters inlet duct 102 with a substantially vertical trajectory, toward fan inlet 110. Guide vane 150 may be positioned and oriented such that upstream end 152 is positioned closer to bottom wall 174 than downstream end 154. In this manner, guide vane 150 is configured to turn the flow of air F more than bottom wall 174, lifting the flow of air F up to direct at least a portion of the flow of air F along the trajectory described above for generating a negative pre-swirl.

According to the illustrated embodiment, guide vane 150 always extends in a plane that is substantially perpendicular to an inner surface of first sidewall 170. In this manner, guide vane 150 generally directs the flow of air F in a plane perpendicular to the axial direction A, but has little effect on the direction of flow along the axial direction A. However, according to alternative embodiments, guide vane 150 may twist or extend along a plane that is not perpendicular to the inner surface of first side wall 170. For example, according to an exemplary embodiment, guide vane 150 may twist about an axis parallel to the radial direction R or may extend from first side wall 150 at an angle of approximately sixty degrees.

Operation of dryer appliance 10 having a fan assembly 100 and guide vane 150 according to exemplary embodiment illustrated in FIG. 5 results in improved appliance performance. For example, FIG. 6 illustrates fan curves of fan assembly 100 both with guide vane 150 configured to generate a negative pre-swirl in inlet chamber 160 and without guide vane 150 (identified as “baseline” curve). The fan curves illustrate the pressure rise across fan assembly 100 versus flow rate through the fan assembly 100.

As illustrated in FIG. 6, the presence of guide vane 150 within inlet duct 102 results in a larger flow rate or pressure rise across fan assembly 100. Notably, this increased pressure rise results in improved performance of dryer appliance 10. In addition, the stall point of the baseline curve is smoothed out, resulting in more stable and improved operation of fan assembly 100 in the stall region of the fan curve. These improvements may be due, at least in part, to the fact that guide vane 150 guides the flow of air F to generate a negative pre-swirl within the inlet chamber 160. The flow of air F is then drawn along the axial direction A through fan inlet 110 while still rotating opposite the direction of rotation 132 of impeller 118 (FIG. 5). As a result, the flow turning angle is increased as the flow of air F impacts concave surface 134 of blades 124 in a direction close to perpendicular. Blades 124 must then turn the flow of air F through a large turning angle to discharge it through passages 126 and out volute 120. This large turning angle results in increased pressure rise and improved dryer performance.

Although FIG. 5 illustrates the use of a single guide vane 150 for generating a negative pre-swirl flow of air F within inlet chamber 160, it should be appreciated that this is only an exemplary configuration used for the purpose of explaining aspects of the present subject matter. Guide vane 150 may be a different size, shape, position, orientation, material, etc. Moreover, more than one guide vane may be used to direct the flow of air F. Other configurations are also possible.

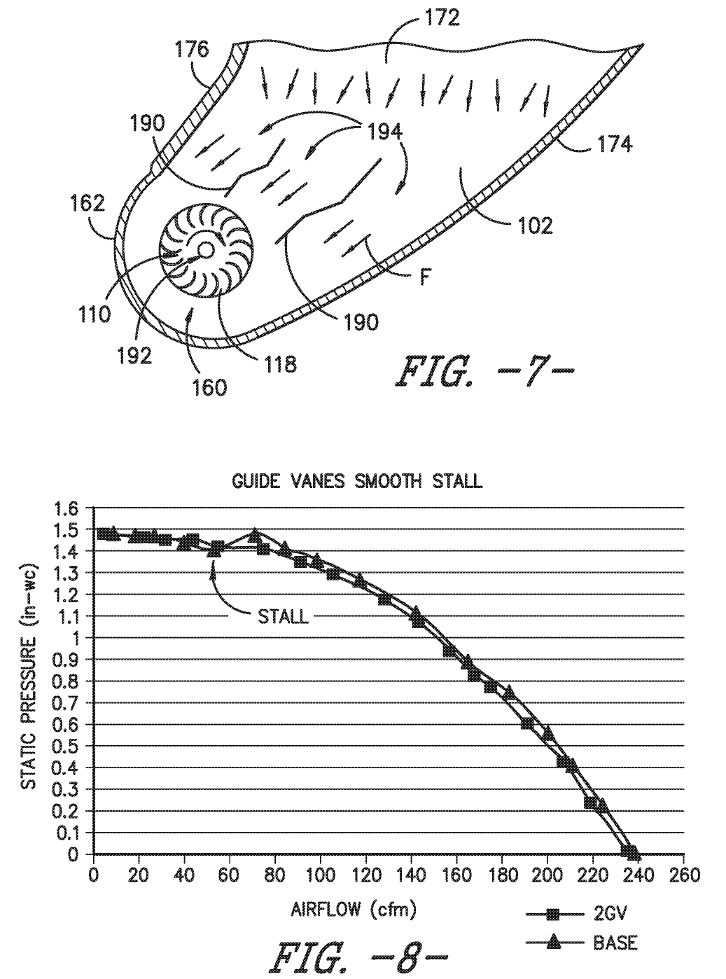

Referring now to FIG. 7, an alternative embodiment of fan assembly 100 will be described which may be used to improve performance of fan assembly 100 in the stall region of the fan curve. For this exemplary embodiment, fan assembly 100 is similar to that described above except that guide vane 150 is removed and replaced by guide vanes 190. Guide vanes 190 may be similar to guide vane 150 in size, shape, material, etc., but are generally positioned and oriented to straighten the flow of air F directly into or towards a center 192 of fan inlet 110.

According to the illustrated embodiment, guide vanes 190 comprise two vanes that are spaced equidistant between bottom wall 174 and top wall 176. In this manner, guide vanes 190 define passageways 194 that are configured to “straighten” the flow of air F prior to entering inlet chamber 160. More specifically, the flow of air F entering inlet duct 102 from chamber 27 is typically turbulent. This turbulence can result in instable performance of fan assembly 100, particularly in the stall region of the fan curve (see FIG. 8). However, by straightening the flow of air F using guide vanes 190, thereby directing a more laminar flow of air F into inlet chamber 160, performance of fan assembly 100 at low flow rate may be more stable.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dryer appliance defining a vertical direction, the dryer appliance comprising:
a cabinet defining a vent;
a drum rotatably mounted within the cabinet, the drum defining a chamber for receipt of articles for drying;
a motor; and
a fan assembly defining an axial direction, a radial direction, and a circumferential direction, the fan assembly comprising:
an impeller, the impeller being in mechanical communication with the motor and rotatable about the axial direction to urge a flow of air from the chamber of the drum to the vent of the cabinet;
an inlet duct that extends between and fluidly couples the chamber and a fan inlet;
a guide vane positioned within the inlet duct and oriented for directing the flow of air within the inlet duct, the guide vane defining an upstream end proximate the chamber and a downstream end proximate the fan inlet, the downstream end of the guide vane defining a tangent line; and
an exhaust duct that extends between and fluidly couples a fan outlet and the vent of the cabinet.

2. The dryer appliance of claim 1, wherein the impeller comprises a base plate and a plurality of blades, the plurality of blades spaced about the base plate along the circumferential direction, each of the plurality of blades defining a concave surface oriented toward a direction of rotation of the impeller,
wherein the tangent line defined by the downstream end of the guide vane is substantially perpendicular to the concave surface of at least one of the plurality of blades.

3. The dryer appliance of claim 1, wherein the inlet duct defines an inlet chamber adjacent the fan inlet along the axial direction, the inlet duct comprising a curved wall at the inlet chamber, the curved wall having a top portion and a bottom portion, wherein the guide vane is positioned and oriented for directing the flow of air onto the top portion of the curved wall such that the flow of air swirls within the inlet chamber in a direction opposite a direction of rotation of the impeller.

4. The dryer appliance of claim 3, wherein the tangent line extends across the impeller proximate the top portion of the curved wall.

5. The dryer appliance of claim 1, wherein the guide vane is positioned and oriented to straighten the flow of air directly into a center of the fan inlet.

6. The dryer appliance of claim 1, wherein the fan assembly comprises two or more guide vanes positioned within the inlet duct.

7. The dryer appliance of claim 1, wherein a length of the guide vane is approximately two times a diameter of the impeller.

8. The dryer appliance of claim 1, wherein the guide vane extends across a depth of the inlet duct, the depth of the inlet duct being defined along the axial direction.

9. The dryer appliance of claim 1, wherein the guide vane extends in one or more planes, each of the one or more planes being perpendicular to a first side wall of the inlet duct.

10. The dryer appliance of claim 1, wherein the guide vane defines a concave surface, the concave surface facing towards the chamber of the drum.

11. The dryer appliance of claim 3, wherein the guide vane extends into the inlet chamber.

12. The dryer appliance of claim 1, wherein the inlet duct defines a curved bottom wall, the upstream end of the guide vane being positioned closer to the curved bottom wall than the downstream end of the guide vane.

13. A fan assembly for urging a flow of air from a chamber of a dryer appliance, the dryer appliance defining a vertical direction, a lateral direction, and a transverse direction that are perpendicular to each other, the fan assembly comprising:
an impeller being rotatable about an axis of rotation in a direction of rotation, the axis of rotation being substantially parallel to the transverse direction;
a fan inlet;
an inlet duct that extends between and fluidly couples the chamber and the fan inlet, the inlet duct being defined by a first side wall and a second side wall separated along the transverse direction and a top wall and a bottom wall separated along the vertical direction; and
a guide vane extending between the first side wall and the second side wall of the inlet duct, the guide vane defining an upstream end proximate the chamber and a downstream end proximate the fan inlet, the downstream end of the guide vane defining a tangent line that substantially aligns with a primary direction of the flow of air.

14. The fan assembly of claim 13, wherein the impeller comprises a base plate and a plurality of blades, the plurality of blades spaced about the base plate along a circumferential direction, each of the plurality of blades defining a concave surface oriented toward the direction of rotation of the impeller,
wherein the tangent line is substantially perpendicular to the concave surface of at least one of the plurality of blades.

15. The fan assembly of claim 13, wherein the guide vane is positioned and oriented to straighten the flow of air such that the tangent line intersects the axis of rotation.

16. The fan assembly of claim 13, wherein the inlet duct defines an inlet chamber adjacent the fan inlet along the transverse direction, the inlet duct comprising a curved wall at the inlet chamber, the curved wall having a top portion and a bottom portion, wherein the guide vane is positioned and oriented for directing the flow of air onto the top portion of the curved wall such that the flow of air swirls within the inlet chamber in a direction opposite the direction of rotation of the impeller.

17. The fan assembly of claim 16, wherein the tangent line extends across the impeller proximate the top portion of the curved wall.

18. The fan assembly of claim 13, wherein the fan assembly comprises two or more guide vanes positioned within the inlet duct.

19. The fan assembly of claim 13, wherein the upstream end of the guide vane is positioned closer to the bottom wall than the downstream end of the guide vane.

20. The fan assembly of claim 13, wherein the guide vane extends in one or more planes, each of the one or more planes being perpendicular to a first side wall of the inlet duct.
